(19) United States
(12) Patent Application Publication
(10) Pub. No.: US 2026/0338207 A1
(43) Pub. Date: Oct. 29, 2026

(54) CONTROL UNITS AND HYDRAULIC SYSTEMS FOR DEMOLITION ROBOTS

(71) Applicant: HUSQVARNA AB, Huskvarna (SE)

(72) Inventor: Masoud VARSHOSAZ, Savedalen (SE)

(21) Appl. No.: 19/115,382

(22) PCT Filed: Sep. 28, 2023
(86) PCT No.: PCT/EP2023/076952

§ 371 Date: Mar. 26, 2025

(30) Foreign Application Priority Data
Sep. 30, 2022 (SE) 2251126-5

(51) Int. Cl. F15B 13/04; E02F 9/22; E02F 9/26; F15B 13/02

(52) U.S. Cl. CPC F15B 13/0401; E02F 9/2203; E02F 9/265; F15B 13/026

(57) ABSTRACT

A control unit (110, 210, 600) for controlling a hydraulic system (120, 220) on a demolition robot (100), the hydraulic system (120, 220) comprising at least one hydraulic valve (900, 950) with an associated valve opening (A) arranged to be controlled by the control unit, where the valve (900, 950) is arranged to control a respective robot actuator (130, 230), the control unit (110, 210, 600) being arranged to obtain a position error of the actuator indicative of a difference between a current position and a desired position of the actuator (130, 230), where the control unit (110, 210, 600) is arranged to configure an allowable pressure drop over the at least one hydraulic valve (900, 950) based on the position error, such that an increasing position error results in an increased allowable pressure drop (p₁−p₂) over the at least one hydraulic valve (900, 950), and where the control unit (110, 210, 600) is arranged to control the valve opening (A) of the hydraulic valve (950) such that the pressure drop over the valve is below the allowable pressure drop (p₁−p₂).

### TECHNICAL FIELD

The present disclosure relates to construction equipment such as a demolition robot, and in particular a semi-autonomous or autonomous demolition robot. There are disclosed hydraulic systems, methods, and control units for hydraulic systems suitable for use with demolition robots.

### BACKGROUND

Demolition robots are relatively light-weight and agile construction machines which can be used for various tasks, such as smaller excavation jobs, demolition, and assembly.

Demolition robots are traditionally controlled by a user via remote control. However, an increasing amount of intelligence is being introduced in the control of the demolition robots, such as semi-autonomous user support functions and also autonomous drive functions.

Such automated control function require highly accurate and responsive actuator control systems. There is a desire for hydraulic systems of reduced latency which are more suited for automated control of the demolition robots.

### SUMMARY

It is an object of the present disclosure to provide faster more agile hydraulic systems for use, e.g., in semi-autonomous and autonomous demolition robots, which can be actuated at increased bandwidth if necessary. This object is at least in part obtained by a control unit for controlling a hydraulic system on a demolition robot. The hydraulic system comprises at least one hydraulic valve, arranged to control a respective robot actuator, with an associated valve opening arranged to be controlled by the control unit. The control unit is arranged to obtain a position error of the actuator indicative of a difference between a current position and a desired position of the actuator, e.g., by receiving data from some type of position sensor, an inertial measurement unit (IMU), or by receiving data indicative of the difference between desired position and current position of the at least one robot actuator from another control unit. The control unit is also arranged to configure an allowable pressure drop over the at least one hydraulic valve based on the position error, such that an increasing position error results in an increased allowable pressure drop over the at least one hydraulic valve, and normally also that a decreasing position error results in a decreased allowable pressure drop over the at least one hydraulic valve or an allowable pressure drop which is reset to some default value. By controlling a valve opening of the hydraulic valve such that the pressure drop over the valve is below the allowable pressure drop, a more power efficient and responsive demolition robot is obtained, able to compensate faster for errors in position of the actuators, which is an advantage. The maximum allowable flow through the hydraulic valve can be increased on-demand in this way by the control unit to more quickly mitigate large position errors which may occur intermittently during operation. The pressure build-up time associated with hydraulic actuation in the construction equipment may also be decreased by the present technique, which is an advantage. The allowable pressure drop is normally decreased again to some predetermined default level when the error has been reduced back to an acceptable level. In other words, the increase in allowable pressure drop is temporary, which means that generally a more traditional allowable pressure drop is used in the control of the hydraulic valves in the system. This reduces component wear and provides a more energy efficient operation compared to when large pressure drops are permanently allowed in the hydraulic system. These are all traits which are particularly desirable in autonomous or semi-autonomous demolition robots.

The maximum allowable pressure drop over the at least one hydraulic valve is in some cases also configured in dependence of a hydraulic flow budget of the hydraulic system, and on a state of at least one other hydraulic valve in the hydraulic system. This way the function of other actuators can be maintained, despite the increase in allowable pressure drop in one or more of the hydraulic valves in the system, which is an advantage. A priority order between actuators can also be configured, such that some actuators will be required to operate at reduced speed in case the position error of some other higher priority actuator increases beyond some associated acceptance criterion. Thus, the control unit may balance operation of the different actuators in the hydraulic system.

According to some aspects, the hydraulic valve is an electronically controlled pressure compensated valve with a configurable pressure difference over the valve arranged to be controlled by the control unit in dependence of the allowable pressure drop over the valve. Thus, the technique can be used together with pressure compensated hydraulic valves, which is an advantage since these valves normally have an at least approximately linear relationship between flow and valve opening, and are therefore easier to actuate by an autonomous or semi-autonomous robotic device.

The control unit may also be arranged to configure the allowable pressure drop over the at least one hydraulic valve by transmitting an electronic control signal to the electronically controlled hydraulic valve. The hydraulic valve may also comprise pressure transducers arranged on both sides of the valve to measure a current pressure drop over the valve. These electronic control and sensor signals can be generated at low latency and propagates fast between the hydraulic valve or valves and the control unit, leading to a highly responsive system where control bandwidth can be adapted with low latency to changes in operating state of the demolition robot.

According to some aspects, the control unit is arranged to receive the current position of the actuator as a signal from a position sensor or a motion sensor such as an IMU associated with the actuator. The control unit may also be arranged to receive the desired position of the actuator as a user input signal or as a control signal from an autonomous or semi-autonomous drive module of the demolition robot. The position error may be determined as an absolute error indicating a distance from the current position of the actuator to the desired position of the actuator. The position error can also be determined as a state error or a hydraulic device, e.g., as the current state of the hydraulic device compared to a desired target state of the hydraulic device. The hydraulic device may be a hydraulic motor having a certain speed (which is a state) or a hydraulic cylinder having a certain piston position (which is also a state).

The control unit is, according to some aspects, also arranged to configure the allowable pressure drop over the at least one hydraulic valve by configuring a variable load sense margin pressure of the hydraulic system pump. This way performance can be increased further, leading to higher ability to compensate rapidly for actuator position errors. The variable load sense margin pressure of the hydraulic system can for instance be configurable between 10 bar and 150 bar.

The control unit can also be arranged to determine an actuator speed based on the received desired position, and configure the allowable pressure drop over the at least one hydraulic valve based on the determined actuator speed, such that an increasing speed results in an increased allowable pressure drop over the at least one hydraulic valve. It is an advantage that the control unit is able to compensate the control bandwidth of the hydraulic system for changes in actuator speed in this manner since it results in a more agile demolition robot.

There are also disclosed methods and construction equipment, such as demolition robots, associated with the same advantages as discussed above in connection to the different apparatuses.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated. Further features of, and advantages with, the present invention will become apparent when studying the appended claims and the following description. The skilled person realizes that different features of the present invention may be combined to create embodiments other than those described in the following, without departing from the scope of the present invention.

### BRIEF DESCRIPTION OF THE DRAWINGS

The present disclosure will now be described in more detail with reference to the appended drawings, where:

FIG. 1 illustrates an example demolition robot;

FIG. 2 shows a control loop for controlling one or more hydraulic actuators;

FIG. 3 is a graph illustrating a desired motion and an actual motion by an actuator;

FIG. 4 schematically illustrates some example functions of position error;

FIG. 5 is a flow chart illustrating methods;

FIG. 6 schematically illustrates a control unit;

FIG. 7 schematically illustrates a computer program product;

FIG. 8 illustrates a pressure-controlled hydraulic valve according to prior art;

FIGS. 9A-B illustrate example variable pressure drop hydraulic valves; and

FIG. 10 shows an electronically controllable pressure compensated hydraulic valve.

### DETAILED DESCRIPTION

Aspects of the present disclosure will now be described more fully with reference to the accompanying drawings. The different devices and methods disclosed herein can, however, be realized in many different forms and should not be construed as being limited to the aspects set forth herein. Like numbers in the drawings refer to like elements throughout.

The terminology used herein is for describing aspects of the disclosure only and is not intended to limit the invention. As used herein, the singular forms “a”, “an” and “the” are intended to include the plural forms as well, unless the context clearly indicates otherwise.

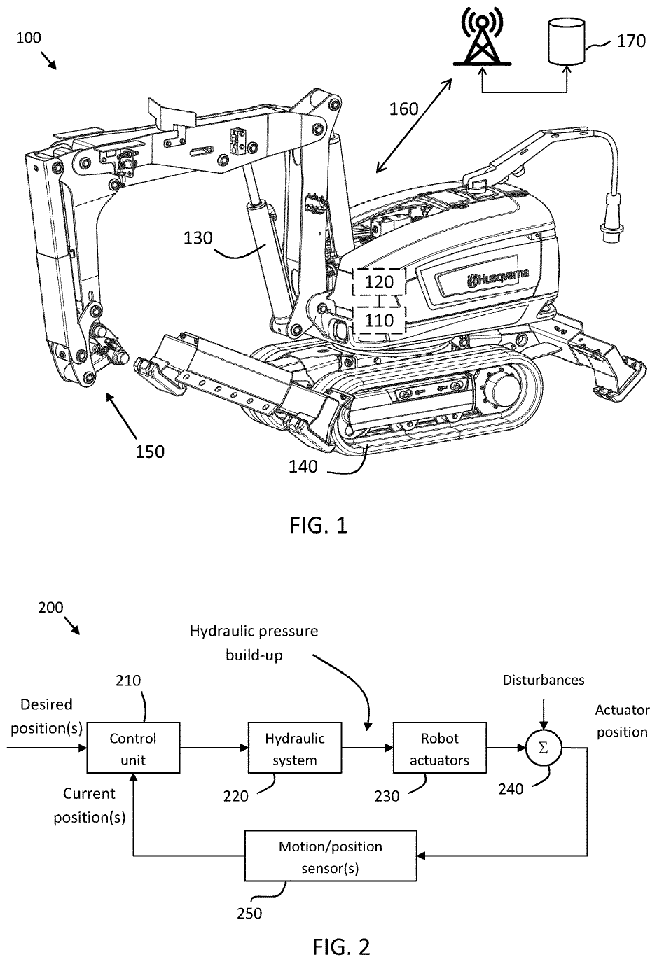

FIG. 1 illustrates an example demolition robot 100, which is an example of construction equipment where the present technical teaching can be applied. A demolition robot is a light-weight construction machine which can be used for various work tasks, such as smaller demolition tasks. The demolition robot is often remote controlled by a user distant from the robot 100, e.g., using a remote control device. The remote control device can be a portable remote control device which can be carried by an operator, e.g., in a harness. Such portable remote control devices can be connected to the robot 100 via cable or via wireless link.

Some demolition robots comprise connectivity systems that allow communication with a remote server 170 over a wireless link 160, which allows remote software upgrade functions and also long distance remote control.

The demolition robot comprises a control unit 110 which controls the general operation of the robot, including the hydraulic system 120 that powers the different actuators 130 on the robot, such as its tracks 140 and the tool carrier 150.

An increasing amount of intelligence is being implemented in demolition robots today, such as functions for semi-autonomous or autonomous control. A semi-autonomous control of the robot may, for instance, involve execution of pre-programmed tasks, such as a given tool maneuver or activation of a tool function. Other examples of semi-autonomous control comprise functions for automatic positioning of tools such as breakers in relation to various work objects, automatic positioning of the demolition robot in a work area, and so on.

FIG. 2 schematically illustrates a control loop 200 for supporting an automated or semi-automated task to be performed by the demolition robot 100. The control unit receives a desired position 210. This desired target position may, e.g., be indicative of a desired pose or location of one or more actuators on the robot in relation to a work object. The desired position may also be indicative of some form of motion to be performed by the demolition robot, which may involve control of several actuators in complex interdependency. The control unit 210, having regard to, e.g., the current position (and possibly also motion) of the different parts of the demolition robot 100, obtained from position sensors 250 on the demolition robot, or from IMUs, then controls the hydraulic system 220 to reduce a difference between the desired position of the actuators and the current position of the actuators. It is noted that the control unit is arranged to obtain a position error of the actuator which is indicative of a difference between the current position and the desired position of the actuator. This position error data can be obtained in different ways, e.g., by receiving current and desired positions and calculating the error, or by directly receiving some signal indicative of the error from some sensor or other control unit.

A position sensor 250 may comprise, e.g., a linear or rotary encoder, an inertial measurement unit, a vision-based sensor, a radar-based sensor, or any other device which provides information related to the position and/or motion of an actuator. The control by the control unit 210 results in a pressure build-up up-stream of the hydraulic actuators of the robot, i.e., the different hydraulic cylinders and motors which generate motion. The actuators are subject to various disturbances 240, such as variation in loads and applied torque.

Motion control of the demolition robot 100 is made complicated by the fact that the control loop involves delay. Each of the components 210, 220, 230, 250 adds some delay to the control loop. Too much delay means that the control will be less accurate, since the control unit becomes less able to respond to abrupt onset of disturbance, for instance.

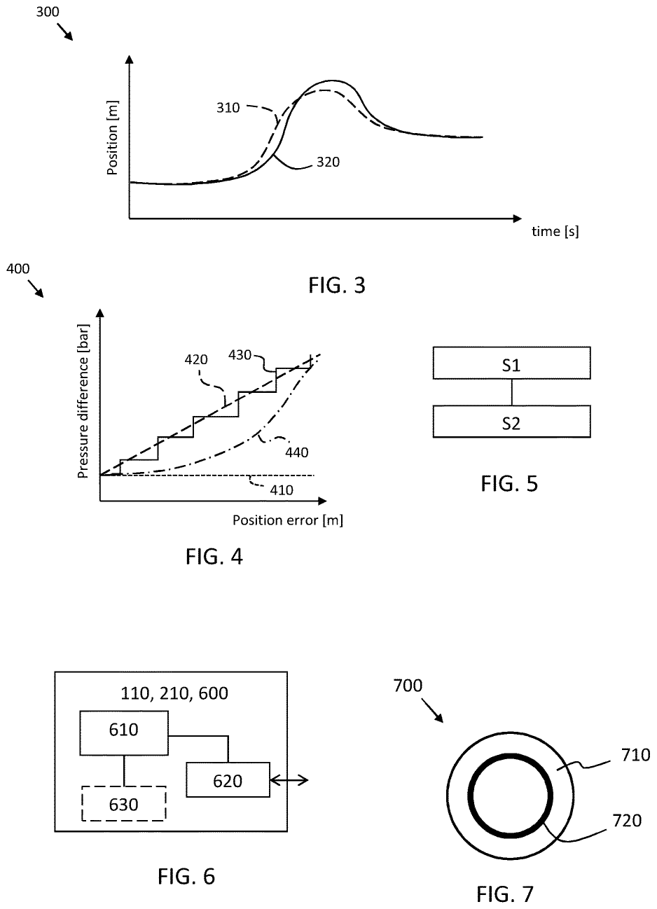

FIG. 3 is a graph 300 which illustrates a desired position 310 of some actuator and an actual position 320 of the actuator. It is noted that there is a difference between the desired position and the actual position. It is desired to minimize this difference.

A main source of delay in the control loop 200 is the pressure build-up time in the hydraulic system. This is the time it takes for the hydraulic system to generate enough pressure to accelerate an actuator from one state to another state. Generally, the force F required to accelerate an object of mass m at acceleration a is F=ma. The force F generated by a hydraulic actuator, such as a cylinder, with area A is F=P·A. For a hydraulic motor, the corresponding formula for applied torque M can be used, i.e., M=V_{g}·P, where V_{g} represents displacement and P is the pressure over the motor. Thus, the time it takes to build pressure P to move an actuator directly influences the delay in the loop 200. Compared to this pressure build-up time, the delay in the control unit (for receiving data and performing calculations) and the latency induced by position sensors is often negligible.

Pressure compensated hydraulic control valves are generally known. These valves regulate the pressure drop over the valve to be constant, regardless of the backpressure seen by the control valve. This allows a linear control of the flow through the valve, which is an advantage since it simplifies the design of the control algorithms implemented in the control unit 210 and is often more intuitive for a user in case of manual control.

Another issue in conventional load sensing (LS) hydraulic systems is that the pressure generated by the hydraulic pump has a constant offset (typically between 14 to 20 bar) compared to the load sensing signal. US 20170089038 A1 describes an example hydraulic system implementing a digital load sense system. This constant offset limits the performance of the system in some cases.

To overcome the aforementioned issues and to speed up the control loop 200, it is proposed herein to instead use a variable maximum allowable pressure drop over the hydraulic control valves in the system, and to configure the allowable pressure drop as an increasing function of position error. For example, when the difference between desired position and actual position of some actuator becomes larger, then the allowed pressure drop over the valve is increased proportionally, thus allowing a larger flow through the valve to be generated by the system. Similarly, when the position error is small, then the allowable pressure difference will also be smaller, i.e., reset to some predetermined default operating value, where energy is better conserved. Pressure transducers can be arranged on the load side of each valve and also on the pressure side of the valves to monitor the pressure drop over the valve in real time, or at least in near real time. A differential pressure transducer can of course also be used with a probe on the load side of the valve and another probe on the pressure side of the valve The valve opening can then be electronically controlled by the control unit to provide the desired pressure drop over the valve (which is a value at or below the allowable pressure drop value), in dependence of the current position error of the actuator. By increasing the allowable pressure drop in this manner, it becomes easier to more quickly reduce position errors, and to provide an overall more responsive system better suited for autonomous or semi-autonomous control.

Generally, the flow q through a hydraulic pressure compensated valve is at least approximately given by

$$q = {C}_{q} A \sqrt{\frac{2}{ρ} ( {p}_{1} - {p}_{2} )}$$

where C_{q} is a valve-specific constant (often about 0,67), A is the valve orifice area (determined by the control unit), p is a parameter related to the density of the hydraulic fluid, p₁ is the system pressure (on the pressure side of the valve) and p₂ is the load pressure acting on the valve.

Thus, it can be seen that by using a larger opening area A of the valve and an increased pressure drop over the valve (p₁−p₂), the flow q to the actuator can be increased, which in turn leads to a decreased latency for pressure build-up, and in most cases also a higher maximum actuator speed. Consequently, by allowing for a larger pressure drop over the valve, a more responsive system can be obtained. To further improve the response time, the system can also use a variable load sensing offset pressure. This can be achieved by use of, e.g., electro proportional controlled pumps or variable speed drive in a load sensing hydraulic system. This increases the system pressure p₁ in the above equation for flow q, which also leads to faster (shorter) response time.

In the equation for q above, the control unit electronically controls A (the valve opening), and may measure both p₁ and p₂, while C_{q} and p are constants which are known a-priori and can be stored in a memory accessible from the control unit. The flow q can of course also be measured directly by use of a flow meter, but these are generally expensive and may not always give accurate results. Hence, basing the hydraulic system on pressure transducers, and avoiding flow meters, is an advantage at least from a system cost perspective.

The control unit, having access to pressure transducer data can, at any given point in time, calculate the flow q through the hydraulic valves in the system controlled in this manner, and therefore also map a desired flow (corresponding to actuator speed and acceleration) to a given valve setting. The control unit can also control flow through one or more valves in the hydraulic system in a relative sense by opening and closing the valve in smaller steps while monitoring actuator position. However, these small steps in valve opening will give different changes in flow q depending on pressure drop p₁−p₂ since this pressure drop is now variable and not fixed as it would have been if a traditional pressure compensated valve had been used. However, it is generally sub-optimal to just open up the valve recklessly to maximize actuator speed, since this could result in too large flow though the valve and consequently that the other valves in the hydraulic system do not receive any flow at all—the flow always takes the easiest path through the hydraulic system. To make sure that the hydraulic valve or valves are not configured by the control unit with a pressure drop over the valve that gives a flow outside of the flow budget for the hydraulic system, the control unit configures a maximum allowable flow through the valve. The control unit then limits the valve opening based on this configured maximum flow, which is done based on the measured pressure drop in real time. It is noted that the maximum allowable pressure drop over the hydraulic valve or valves can also be limited because of reasons other than flow. For example, the maximum pressure drop over a valve shall normally not exceed a valve specification value, since a too high pressure drop may destabilize the valve controllability and/or cause the valve to close or exhibit resonance, which is undesired.

The control unit may maintain a priority list of different actuators. This priority list may be configured, e.g., as a predetermined list or as a function of a given work task or tool selection by the demolition robot, such as if a breaker or a bucket is mounted to the tool carrier 150. The control unit, having regard to the current position error for one or more actuators will configure the allowable pressure drop over the respective hydraulic valves as function of the position errors, such that large error actuators are permitted more flow to speed up actuation and reduce the position error. To still keep the flow budget of the hydraulic system, the allowable pressure drops of actuators with lower priority can be reduced in order to free up more flow to actuate the higher priority actuators. This way the control unit is able to balance operation of the different actuators in the system to both keep position error small and at the same time maintain some form of rudimentary function in the system.

A hydraulic valve controlled by the control unit to have a pressure drop over the valve which never exceeds the configured allowable pressure drop can be referred to as a pressure compensated valve, even though no mechanical pressure compensator is present. Traditional pressure compensated hydraulic valves maintain a constant pressure drop p₁−p₂ over the valve regardless of flow q. This type of valve is primarily designed for keeping a linear relationship between flow and valve opening over different load pressures. The valve 950 is not a traditional pressure compensated valve since the pressure drop p₁−p₂ over the valve varies every time A changes. However, the whole system 950, including pressure transducers and control unit can be considered as an electronically controlled pressure compensated valve.

Two examples of the teachings herein will now be given.

In the first example the position error is small, and it is desired to move the boom of a demolition robot a given distance. In this case the error is small, so the allowable pressure drop over the hydraulic valve which controls the boom is relatively small, say p₁−p₂<8 bar. The control unit opens up the valve (increasing opening A) to a point where p₁−p₂=8 bar, which moves the boom, and then closes the valve again when the boom reaches the desired position.

In the second example the position error is instead large, and we want to move the same boom the same given distance. In this case the allowable maximum pressure drop is larger, say p₁−p₂<80 bar. The control unit opens up the valve (increasing opening A) to a point where p₁−p₂=80 bar. The allowable pressure drop of 80 bars is still a controlled value, determined so as to not jeopardize the overall function of the machine or cause damage to hydraulic components, but will allow a faster action by the boom.

The maximum allowable pressure drop for a given hydraulic valve in the system can be calculated at any given point in time. This can, for instance, be done by considering the maximum available flow in the system (basically the pump capacity) and the maximum pressure drop for each valve. In case of large position error at some actuator, other actuators may need to run with reduced speed until the error is acceptable again.

The pressure drop over a hydraulic valve and the flow through the valve are related to each other, but the relation depends on how the hydraulic system is designed. With a pressure compensated valve, higher allowed pressure drop means higher flow through the valve and thus higher acceleration of the load on the valve. However, if the pressure compensator is removed such that a non-compensated valve is obtained, then a higher pressure drop instead means less flow to the consumer (i.e., the inverse effect). This is because the pump flow can be considered as constant in this case and more pressure drop over the valve means less pressure and flow to the load. If it is desired to increase acceleration of an actuator using a non-compensated valve then the valve should be opened up as much as possible, which gives a lower pressure drop over the valve but a higher pressure and flow to the load.

If a valve is used in a load sensing system (which is not necessarily always the case since it can be used in a constant pressure system, a constant flow system, or any other type of system) the maximum pressure drop is the load pressure margin of the pump i.e. if a hydraulic pump has a load pressure margin of say 17 bar the maximum pressure drop over the valve is 17 bar, and the pump will reduce the system flow if the pressure drop is about to exceed the pressure margin. In this case, if a non-compensated valve is used, the pressure drop over the valve can be increased by increasing the load sensing pressure margin, i.e. the pressure margin can be on the order of 100 bar (if the valve technically allows it) in order to obtain a larger pressure drop and consequently also flow through the valve, which increases the acceleration and speed of the actuator.

According to some aspects of the present disclosure, it is proposed to replace the classic spring loaded pressure compensated valves by electronically controlled valves without mechanical compensator which mimic the operation of a spring loaded pressure compensated valve, by modulating valve opening in response to an electronic control signal.

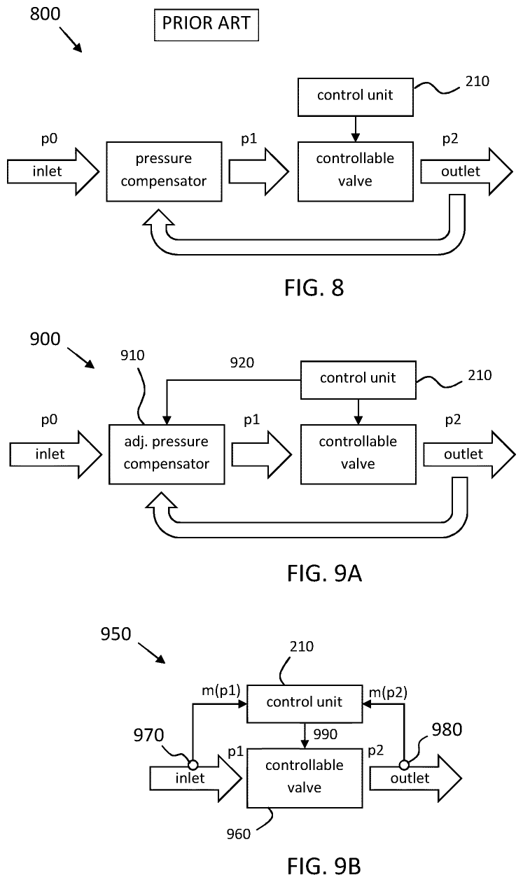

FIG. 8 illustrates a traditional pressure-compensated hydraulic valve 800. This valve is configured to maintain a constant pressure drop p₁−p₂ over the valve, independently of the load on the valve, meaning that the pressure compensator normally decreases the system pressure p₀ to a lower valve upstream pressure p₁. A significant amount of pressure is often lost due to the pressure compensator. A common reason for using pressure compensated valves in hydraulic system is that they give a more linear behavior of the valve. Pressure-compensated hydraulic valves are generally known and will therefore not be discussed in more detail herein.

FIGS. 9A and 9B illustrate example hydraulic valves according to the present teaching, where the pressure drop p₁−p₂ over the valve can be configured by the control unit 210 in real time or at least in near real-time.

The valve 900 in FIG. 9A has an adjustable pressure compensator 910, which can be electronically configured 920 by the control unit 210 to maintain a desired pressure drop over the valve. This means that the control unit 210 can increase the pressure drop p₁−p₂ over the valve if more flow is desired or decrease the pressure drop if high flow is not needed. The adjustable pressure compensator 910 can, e.g., be realized using an actuator configured to adjust the spring of a spring-loaded pressure compensated valve.

The valve 950 in FIG. 9B lacks pressure compensation. Instead it comprises a controllable valve 960 which is controlled from the control unit 210 to maintain a desired pressure drop over the valve. The current pressure drop is continuously or periodically measured by pressure transducers 970, 980 which report measured pressures m(p₁) and m(p₂) to the control unit 210. In this manner the control unit can limit the pressure drop over the valve to be below an allowable pressure drop.

To summarize, with reference also to FIG. 6 which will be discussed in more detail below, there is disclosed herein a control unit 110, 210, 600 for controlling a hydraulic system 120, 220 on a demolition robot 100, where the hydraulic system 120, 220 comprises at least one hydraulic valve arranged to control a respective robot actuator 130, 230. The control unit is arranged to obtain a position error of the actuator indicative of a difference between a current position and a desired position of the actuator, e.g., by receiving data indicative of the desired position and the current position of the at least one robot actuator. The control unit 110, 210, 600 is also arranged to configure an allowable pressure drop over the at least one hydraulic valve based on the position error, such that an increasing position error results in an increased pressure drop over the at least one hydraulic valve. The configuration of allowable pressure drop value as function of position error can be obtained from a predetermined function such as a look-up table. This predetermined function can be fixed or adjustable by a user of the system. A fixed function that maps position error to allowable pressure drop can be determined based on computer simulation and/or based on practical experimentation. Thus, in essence, the system adapts the bandwidth of the control loop in dependence of the current position error of the actuator by changing the allowable pressure drop. A small error gives a smaller allowable pressure drop, since then a longer pressure build-up time can be tolerated, while a larger position error results in a larger allowable pressure drop to obtain a shorter pressure build-up time.

It is appreciated that the control unit 210 may be realized as a collection of modules, physically and/or logically separated from each other. Hence, a control system comprising a first module or unit arranged to receive or determine the desired position, a second module or unit arranged to receive or determine the current position of the at least one robot actuator, and a third unit or module arranged to determine the position error as the difference between the current position and the desired position of the actuator is considered a control unit herein.

FIG. 4 shows a graph 400 where some example relationships between obtainable pressure drop over a valve and position error is shown. A traditional pressure compensated valve 410 does not modulate the obtainable pressure difference in dependence of position error. The dependency between position error and obtainable pressure drop over the valve can be a linear or an affine relationship, as exemplified by the dashed line 420. Alternatively, the relationship can be a stepwise increasing function, such as the example 430, or a non-linear increasing function 440.

As discussed above in connection to FIGS. 9A and 9B, the hydraulic valve can be realized as an electronically controlled pressure compensated valve 900, 950 with a configurable pressure difference over the valve which can be set 920, 990 from the control unit 210. For instance, the classic spring-based pressure compensator mechanism can be replaced by an electronically controlled valve without fixed spring loaded pressure compensator, possibly complemented by pressure transducers 970, 980 arranged on both sides of the valve to measure a current pressure drop over the valve. The control unit can then control the opening area of the valve orifice to obtain a desired pressure drop over the valve. In other words, the control unit 110, 210, 600 is, according to some aspects, arranged to control a valve opening of the hydraulic valve to obtain a desired pressure drop over the valve, e.g., by transmitting an electronic control signal 920, 990 to the hydraulic valve.

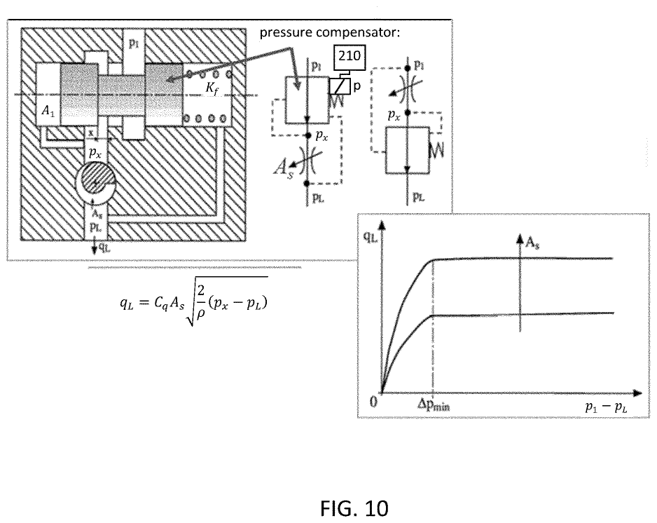

FIG. 10 illustrates an electronically controlled pressure compensated valve with configurable constant pressure drop over the valve (the pressure drop over the valve is maintained at a target value regardless of valve opening as in a normal pressure compensated hydraulic valve, but the target value is configurable from the control unit as indicated in the Figure). In this example, p_{L} is the load pressure (referred to as p₂ above), pₓ is an intermediate pressure close to the valve opening Aₛ, x is the pressure compensator displacement, A₁ is a hydraulic area, and K_{f} is a spring constant of the spring-loaded pressure compensated valve. The control unit 210, having regard to the position error of the different actuators and parts of the demolition robot, adjusts the bandwidth of the hydraulic control to generate more or less flow through the valve—the higher the flow the faster the actuation by the actuator. Hence, if the control unit 210 observes a growing position error despite controlling the actuator at maximum speed, the allowable pressure drop over the valve can be increased by transmitting an electronic control signal to the hydraulic valve resulting in an increase in the allowable pressure drop over the valve and thus also an increased maximum flow q_{L}. This increase in allowable pressure drop means that more flow will result from a maximum opening of the valve orifice. The control unit 210 may also have regard to the total flow budget in the hydraulic system, and control the allowable pressure drop over the valve such that the other hydraulic flows in the system are also supported, at least on some rudimentary flow level where basic functionality can be maintained. The allowable pressure drop over the valves in the hydraulic system may be configured according to some predetermined priority order. The actual mapping between position error and allowable pressure drops in the system is preferably obtained from a predetermined function or look-up table, as discussed above. However, user adjustment and work task specific adaptations can of course also be allowed.

The control unit 110, 210, 600, may also be arranged to configure the allowable pressure drop over the at least one hydraulic valve by configuring a variable load sense margin pressure of the hydraulic system 120, 220. This means that the control unit is able to increase the system pressure at least temporarily to allow for larger pressure drops across one or more control valves than would otherwise have been possible. According to an example, the control unit 110, 210, 600 may be arranged to change the variable load sense margin pressure from a minimum level of about 10 bar to a maximum level on the order of 100 bar or more, such as 150 bar, i.e., a significant increase in load sense margin pressure, i.e., in the load sensing delta pressure of the hydraulic pump. This variable load sense margin is preferably also controlled using a pre-determined relationship between position error and load sense margin in the system.

According to some aspects, the control unit 110, 210, 600 is arranged to receive the current position of the actuator as a signal from a position sensor or a motion sensor associated with the actuator 130, 230. This sensor may, for instance, be realized as a linear transducer to measure the position of a cylinder, or a rotary encoder to measure rotation of a rotatable actuator such as a motor, or an inertial measurement unit (IMU) which measures accelerations. Other more advanced sensor systems may comprise vision-based sensors such as cameras, lidar systems, radar systems, and the like. The control unit may also be arranged to obtain the position error directly from some other control unit or sensor system.

The control unit 110, 210, 600 may furthermore be arranged to receive the desired position of the actuator as a user input signal or as a control signal from an autonomous or semi-autonomous drive module of the demolition robot 100. Thus, the systems discussed herein are applicable both with manually controlled systems where a user inputs desired position, for instance via a remote control, and also with autonomous of semi-autonomous systems where the controls are generated automatically, either directly by the control unit 230 or by some external control module.

According to some further aspects, the control unit 110, 210, 600 may also be arranged to determine an actuator speed based on the received desired position, and to configure the allowable pressure drop over the at least one hydraulic valve based on the determined actuator speed, such that an increasing speed results in an increased pressure drop over the at least one hydraulic valve. Thus, if the received control input is indicative of a high speed movement by the robot, then the maximum obtainable pressure drop over the valve is increased in the same manner as discussed above.

The techniques disclosed herein can also be described in terms of a method, which is illustrated by the flow chart in FIG. 5. FIG. 5 illustrates a computer-implemented method performed by the control unit 110, 210, 600 discussed herein, for controlling a hydraulic system 120, 220 on a demolition robot 100, where the hydraulic system 120, 220 comprises at least one hydraulic valve 900, 950 with an associated valve opening A arranged to be controlled by the control unit, and where the valve 900, 950 is arranged to control a respective robot actuator 130, 230. The method comprises obtaining S1, by the control unit, a position error of the actuator indicative of a difference between a current position and a desired position of the actuator 130, 230, and configuring S2, by the control unit, an allowable pressure drop over the at least one hydraulic valve 900, 950 based on the position error, such that an increasing position error results in an increased allowable pressure drop p₁−p₂ over the at least one hydraulic valve 900, 950.

It is appreciated that the control unit 210 may be able to determine the position error using sub-units (possibly distanced physically from the main control unit 210) that determine the desired and current position. Hence, in some realizations the control unit 210 performing the configuring of the allowable pressure drop may just receive the position error directly.

FIG. 6 schematically illustrates, in terms of a number of functional units, the general components of the control unit 600, such as the control units 110, 210 discussed above. Processing circuitry 610 is provided using any combination of one or more of a suitable central processing unit CPU, multiprocessor, microcontroller, digital signal processor DSP, etc., capable of executing software instructions stored in a computer program product, e.g., in the form of a storage medium 630. The processing circuitry 610 may further be provided as at least one application specific integrated circuit ASIC, or field programmable gate array FPGA.

Particularly, the processing circuitry 610 is configured to cause the demolition robot 100 to perform a set of operations, or steps, such as the methods discussed in connection to FIG. 5 and the discussions above. For example, the storage medium 630 may store the set of operations, and the processing circuitry 610 may be configured to retrieve the set of operations from the storage medium 630 to cause the device to perform the set of operations. The set of operations may be provided as a set of executable instructions. Thus, the processing circuitry 610 is thereby arranged to execute methods as herein disclosed.

The storage medium 630 may also comprise persistent storage, which, for example, can be any single one or combination of magnetic memory, optical memory, solid state memory or even remotely mounted memory.

The control unit 600 may further comprise an interface 620 for communications with at least one external device. As such the interface 620 may comprise one or more transmitters and receivers, comprising analogue and digital components and a suitable number of ports for wireline or wireless communication.

The processing circuitry 610 controls the general operation of the control unit 600, e.g., by sending data and control signals to the interface 620 and the storage medium 630, by receiving data and reports from the interface 620, and by retrieving data and instructions from the storage medium 630.

FIG. 7 illustrates a computer readable medium 710 carrying a computer program comprising program code means 720 for performing the methods illustrated in FIG. 5, when said program product is run on a computer. The computer readable medium and the code means may together form a computer program product 700.

1. A control unit for controlling a hydraulic system on a demolition robot, the hydraulic system comprising at least one hydraulic valve with an associated valve opening arranged to be controlled by the control unit, wherein the valve is arranged to control a respective robot actuator,
the control unit being arranged to obtain a position error of the actuator indicative of a difference between a current position and a desired position of the actuator,
wherein the control unit is arranged to configure an allowable pressure drop over the at least one hydraulic valve based on the position error, such that an increasing position error results in an increased allowable pressure drop over the at least one hydraulic valve, and
wherein the control unit is arranged to control the valve opening of the hydraulic valve such that the pressure drop over the valve is below the allowable pressure drop.

2. The control unit according to claim 1, wherein the allowable pressure drop over the at least one hydraulic valve is also configured in dependence of a predetermined hydraulic flow system budget of the hydraulic system, and on a state of at least one other hydraulic valve or function in the hydraulic system.

3. The control unit according to claim 1, wherein the hydraulic valve is an electronically controlled pressure compensated valve with a configurable pressure difference over the valve arranged to be controlled by the control unit in dependence of the allowable pressure drop over the valve.

4. The control unit according to claim 1, arranged to configure the allowable pressure drop over the at least one hydraulic valve by transmitting an electronic control signal to the electronically controlled hydraulic valve.

5. The control unit according to claim 1, wherein the hydraulic valve comprises pressure transducers arranged on both sides of the hydraulic valve to measure a current pressure drop over the valve.

6. The control unit according to claim 1, arranged to receive the current position of the actuator as a signal from a position sensor or a motion sensor associated with the actuator.

7. The control unit according to claim 1, arranged to receive the desired position of the actuator as a user input signal or as a control signal from an autonomous or semi-autonomous drive module of the demolition robot.

8. The control unit according to claim 1, arranged to configure a variable load sense margin pressure associated with a hydraulic pump of the hydraulic system.

9. The control unit according to claim 8, wherein the variable load sense margin pressure of the hydraulic system is configurable between 10 bar and 150 bar.

10. The control unit according to claim 1, arranged to determine an actuator speed based on the received desired position, wherein the control unit is arranged to configure the allowable pressure drop over the at least one hydraulic valve based on the determined actuator speed, such that an increasing speed results in an increased allowable pressure drop over the at least one hydraulic valve.

11. A demolition robot-comprising a hydraulic system with at least one hydraulic valve arranged to control a respective robot actuator, and the control unit according to claim 1.

12. A computer-implemented method performed by a control unit for controlling a hydraulic system on a demolition robot, wherein the hydraulic system comprises at least one hydraulic valve with an associated valve opening arranged to be controlled by the control unit, wherein the valve is arranged to control a respective robot actuator, the method comprising
obtaining, by the control unit, a position error of the actuator indicative of a difference between a current position and a desired position of the actuator,
configuring, by the control unit, an allowable pressure drop over the at least one hydraulic valve based on the position error, such that an increasing position error results in an increased allowable pressure drop over the at least one hydraulic valve, and
controlling, by the control unit, the valve opening of the hydraulic valve such that the pressure drop over the valve is below the allowable pressure drop.
